(19) United States
(12) Patent Application Publication
(10) Pub. No.: US 2004/0217874 A1
(43) Pub. Date: Nov. 4, 2004

(54) Article with an electrical load powered by an induction generator

(76) Inventor: Shih-En Tsou, Tao-Yuan City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/426,722

(22) Filed: May 1, 2003

(51) Int. Cl. G08B 21/00

(52) U.S. Cl. 340/686.1

(57) ABSTRACT

An article includes a main body, an electrical load on the main body, and a magnet unit and a sensing coil unit that constitute an induction generator which is connected to the electrical load. The main body is provided with an elongated compartment that extends along a longitudinal axis, and has opposite first and second ends along the longitudinal axis. The main body is movable so as to alternate between a first state, where the first end is disposed higher than the second end, and a second state, where the second end is disposed higher than the first end. The magnet unit and the sensing coil unit are mounted on the main body and are capable of relative movement therebetween by virtue of gravity so that electrical current is induced in the sensing coil unit when the main body alternates between the first and second states.

### BACKGROUND OF THE INVENTION

1. Field of the Invention

The invention relates to an article with an electrical load, more particularly to an article with an electrical load powered by an induction generator.

2. Description of the Related Art

Objects, such as bicycles, shoes, yo-yos, etc., are often mounted with passive light-reflecting devices or active light-generating devices for warning or aesthetic purposes.

Passive light-reflecting devices, usually in the form of light-reflecting stickers adhered on the surface of objects, rely on the presence of light rays for reflection. Therefore, when there is no incident light, the passive light-reflecting device will not function. Moreover, passive light-reflecting devices can only reflect incident light to a specific reflective direction, and thus cannot provide reflected light of relatively high luminance and dispersed at wide angles.

Therefore, if cost is not a factor to be considered, active light-generating devices are a more ideal choice. Active light-generating devices are usually powered electrically, either through batteries or generators. However, batteries can harm the environment, and have limited power storage capacities. Moreover, if high luminance and long duration of use are desired, relatively large and heavy batteries are adopted, which can result in other problems during use. For example, a bicycle mounted with a car battery would result in extra effort for the rider.

As such, light-generating devices on a bicycle are usually powered using a generator. A conventional generator for bicycle use typically includes a main generator body mounted on the bicycle frame and a generator axle in contact with a bicycle wheel, which impose restrictions on installation positions and on the design of the bicycle. Hence, a tremendous change in the bicycle structure is necessary. Moreover, the light-generating devices powered by the known generator can hardly be installed on moving objects, such as bicycle wheels, shoes, yo-yos, etc., in view of electrical connection considerations.

### SUMMARY OF THE INVENTION

Therefore, the object of the present invention is to provide an article with an electrical load powered by an induction generator that can overcome the aforesaid drawbacks of the prior art.

Accordingly, an article of this invention comprises:

a main body provided with an elongated compartment that extends along a longitudinal axis, the compartment having opposite first and second ends along the longitudinal axis, the compartment further having a first region adjacent to the first end, and a second region adjacent to the second end, the main body being movable so as to alternate between a first state, where the first end is disposed higher than the second end relative to a horizontal plane, and a second state, where the second end is disposed higher than the first end relative to the horizontal plane;

an electrical load mounted on the main body; and

an induction generator mounted on the main body and including a magnet unit and a sensing coil unit.

One of the magnet unit and the sensing coil unit is movably disposed in the compartment such that said one of the magnet unit and the sensing coil unit moves into the second region of the compartment by virtue of gravity when the main body is at the first state, and such that said one of the magnet unit and the sensing coil unit moves into the first region of the compartment by virtue of gravity when the main body is at the second state.

The other one of the magnet unit and the sensing coil unit is fixed relative to the compartment and is disposed adjacent to one of the first and second regions of the compartment.

Back and forth movement of said one of the magnet unit and the sensing coil unit in the first and second regions of the compartment induces electrical current in the sensing coil unit.

The sensing coil unit is coupled electrically to the electrical load so as to supply electrical power thereto when the main body is moved so as to alternate between the first and second states.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic side view of the first preferred embodiment of an article with an electrical load powered by an induction generator according to the present invention;

FIG. 2 is a schematic bottom view of the first preferred embodiment;

FIG. 3 is a perspective, partly cutaway view to illustrate an induction generator and an electrical load of the first preferred embodiment;

FIG. 4 is a schematic top view to illustrate an operating state of the induction generator of the first preferred embodiment;

FIG. 5 is a schematic top view to illustrate another operating state of the induction generator of the first preferred embodiment;

FIG. 6 is a perspective, partly cutaway view to illustrate an induction generator of the second preferred embodiment of an article according to the present invention;

FIG. 7 is a schematic sectional view illustrating an operating state of an induction generator of the third preferred embodiment of an article according to the present invention;

FIG. 8 is a schematic sectional view illustrating another operating state of the induction generator of the third preferred embodiment; and

FIG. 9 is a schematic side view of the fourth preferred embodiment of an article with an electrical load powered by an induction generator according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

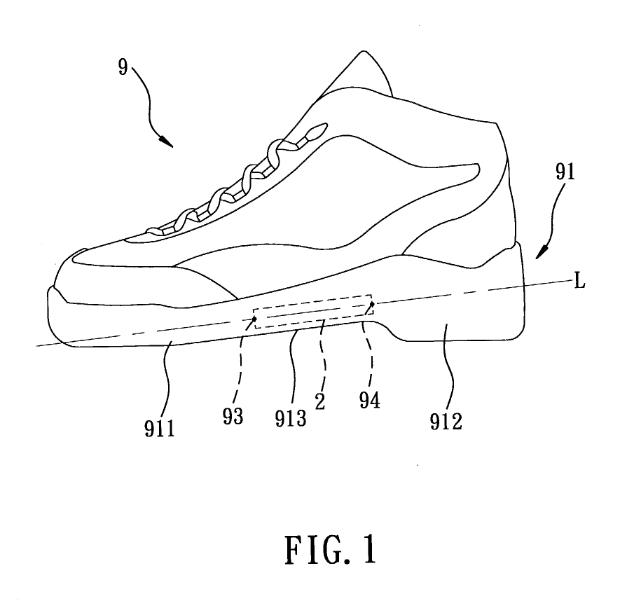

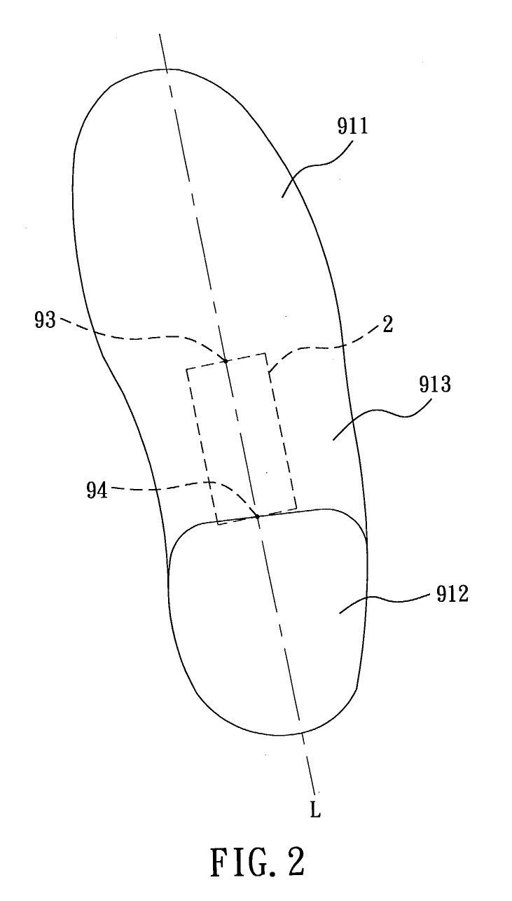

Referring to FIGS. 1 and 2, the first preferred embodiment of an article according to the present invention is shown to include a main body in the form of a shoe 9 having a shoe sole 91. The shoe sole 911 defines a longitudinal axis (L), and has toe and heel portions 911; 912 opposite to each other along the longitudinal axis (L), and an intermediate sole portion 913 between the toe and heel portions 911, 912. In this embodiment, a rectangular casing 2 is embedded in the intermediate sole portion 913.

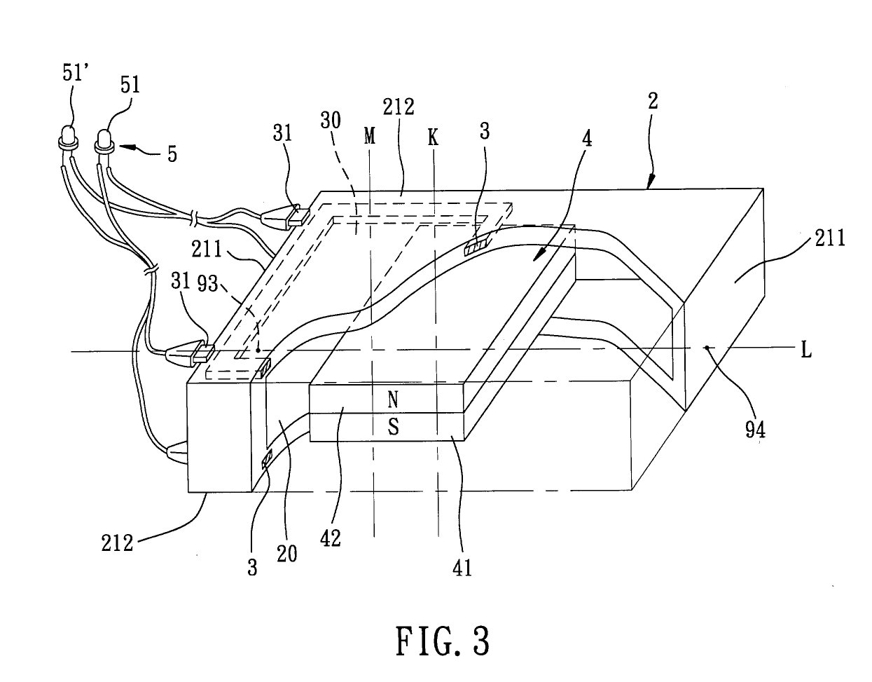

With further reference to FIGS. 3, 4 and 5, the casing 2 confines an elongated compartment 20 that extends along the longitudinal axis (L). The compartment 20 has opposite first and second ends 93, 94 along the longitudinal axis (L). The first end 93 is proximate to the toe portion 911, whereas the second end 94 is proximate to the heel portion 912. The first and second ends 93, 94 of the compartment 20 are closed by two first walls 211, respectively. The casing 2 further has a pair of second walls 212 that interconnect the first walls 211. The compartment 20 further has a first region adjacent to the first end 93, and a second region adjacent to the second end 94. In use, when the shoe 9 is worn, and the wearer of the shoe 9 walks, the casing 2 is moved together with the shoe 9 relative to the ground so as to alternate between a first state, where the first end 93 is disposed higher than the second end 94 relative to a horizontal plane such as when the toe portion 911 is lifted from the ground and the heel portion 912 rests on the ground, and a second state, where the second end 94 is disposed higher than the first end 93 relative to the horizontal plane such as when the toe portion 911 rests on the ground and the heel portion 912 is lifted from the ground.

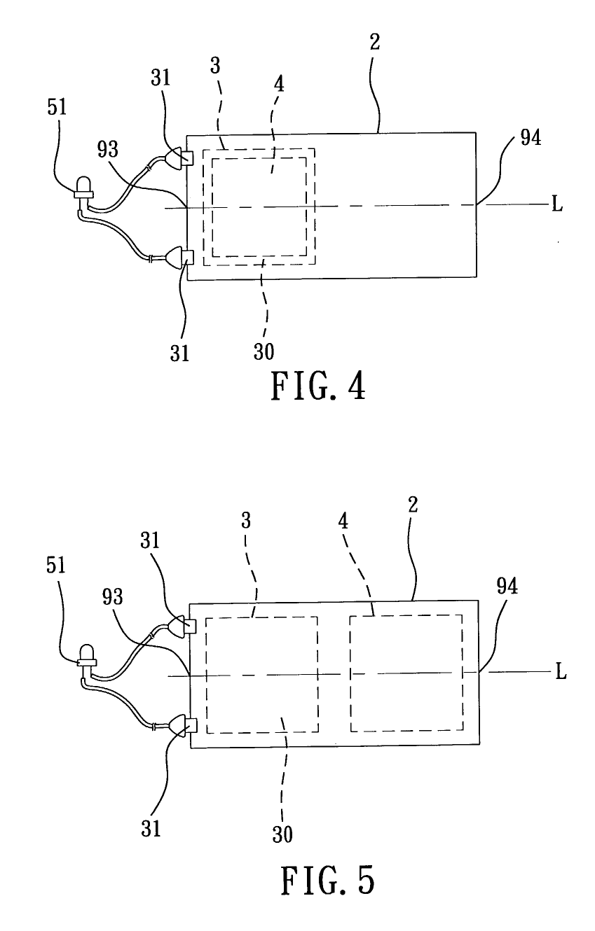

The article of this embodiment further includes an induction generator and an electrical load. In this embodiment, the induction generator includes a magnet unit and a sensing coil unit. The magnet unit includes a permanent magnet 4 having a south magnetic pole 41 and a north magnetic pole 42. The permanent magnet 4 is movably disposed in the compartment 20 such that the permanent magnet 4 moves into the second region of the compartment 20 by virtue of gravity when the casing 2 is at the first state (see FIG. 5), and such that the permanent magnet 4 moves into the first region of the compartment 20 by virtue of gravity when the casing 2 is at the second state (see FIG. 4). The permanent magnet 4 defines a magnet axis (K) transverse to the longitudinal axis (L).

The sensing coil unit is fixed relative to the compartment 20. In this embodiment, the sensing coil unit includes a pair of coil members 3, each of which is embedded in a respective one of the second walls 212 of the casing 2 and has a sensing area 30 disposed adjacent to the first region of the compartment 20. The sensing areas 30 of the coil members 3 have aligned coil axes (M) parallel to the magnet axis (K), and the second walls 212 of the casing 2 are opposite to each other along the coil axes (M). Each coil member 3 has a pair of output terminals 31.

As mentioned above, the permanent magnet 4 moves back and forth between the first and second ends 93, 94 of the compartment 20 along the longitudinal axis (L) by virtue of gravity due to alternating movement of the casing 2 between the aforesaid first and second states. When the permanent magnet 4 is disposed in the first region of the compartment 20, the magnet axis (K) is registered with the sensing areas 30 of the coil members 3, as shown in FIG. 4. On the other hand, when the permanent magnet 4 is disposed in the second region of the compartment 20, the magnet axis (K) is not registered with the sensing areas 30 of the coil members 3, as shown in FIG. 5. Back and forth movement of the permanent magnet 4 in the aforesaid manner induces electrical current due to magnetic flux changes in the coil members 3.

The electrical load in this embodiment is in the form of a lamp unit 5 that is mounted on any appropriate location of the shoe 9 and that includes a pair of light-emitting diodes (LED) 51, 51′ connected electrically to a respective pair of the output terminals 31 of the coil members 3. In practice, each of the diodes 51, 51′ may be replaced by an incandescent light bulb, which can be easily inferred by those skilled in the art. Due to the electrical current induced in the coil members 3, and the electrical connection between the coil members 3 and the lamp unit 5, electrical power can be supplied intermittently to the lamp unit 5 when the casing 2 is moved together with the shoe 9 relative to the ground so as to alternate between the first and second states.

In this embodiment, the sensing coil unit includes a pair of coil members 3. In practice, even if the sensing coil unit includes only one coil member 3 mounted in one of the second walls 212, the same effect as described hereinabove will be rendered.

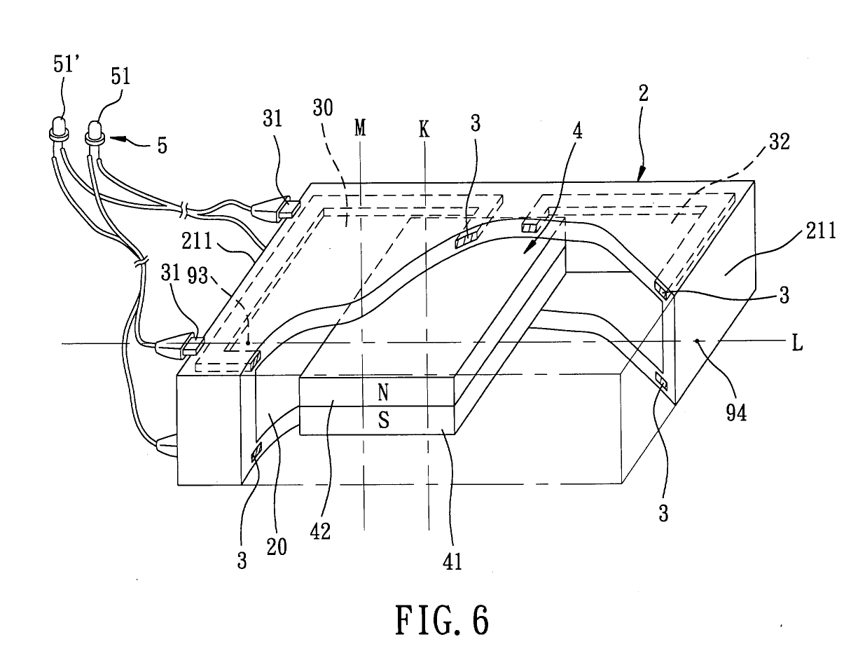

Referring to FIG. 6, in the second preferred embodiment of this invention, the sensing coil unit further includes another pair of coil members 3, each of which is embedded in a respective one of the second walls 212 of the casing 2 and has a sensing area 32 disposed adjacent to the second region of the compartment 20. It is apparent that back and forth movement of the permanent magnet 4 between the first and second regions of the compartment 20 can induce electrical currents in the two pairs of coil members 3, which in turn can be supplied to the lamp unit 5.

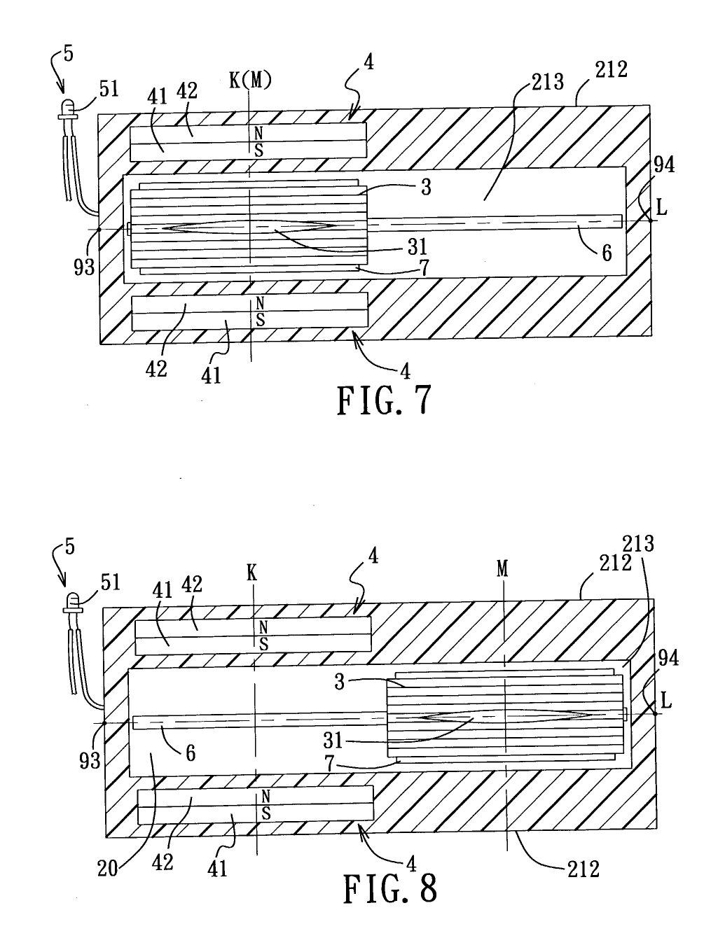

The operating principle of current induction is based on the fact that electrical currents are induced by magnetic flux changes in a sensing coil, the magnetic flux changes being a result of relative movement between the sensing coil and a magnet. As such, as shown in FIGS. 7 and 8, the third preferred embodiment of an article according to this invention is shown to differ from the previous embodiments primarily in the construction of the induction generator. In the third preferred embodiment, the magnet unit includes a pair of permanent magnets 4, each of which is embedded in a respective one of the second walls 212 of the casing 2 and is disposed adjacent to the first region of the compartment 20. The sensing coil unit includes a single coil member 3 movably disposed in the compartment 20. The coil member 3 includes a core 7 and a coil 31 wound on the core 7. The casing 2 further includes a pair of opposite third walls 213 connected to the first and second walls 211, 212. Two conductive slide rails 6 are mounted respectively on the third walls 213 in the compartment 20, extend parallel to the longitudinal axis (L), and are spaced apart from each other in a direction transverse to the longitudinal and coil axes (L), (M). The coil member 3 is in sliding engagement with the slide rails 6 and establishes electrical connection with the slide rails 6. The slide rails 6 are coupled electrically to the lamp unit 5.

Unlike the previous embodiments, the coil member 3 moves into the second region of the compartment 20 (see FIG. 8) by virtue of gravity when the casing 2 is at the first state, and into the first region of the compartment 20 (see FIG. 7) by virtue of gravity when the casing 2 is at the second state. When the coil member 3 is disposed in the first region of the compartment 20, the magnet axes (K) are registered with the coil axis (M) of the coil member 3, as shown in FIG. 7. On the other hand, when the coil member 3 is disposed in the second region of the compartment 20, the magnet axes (K) are not registered with the coil axis (M) of the coil member 3, as shown in FIG. 8. Back and forth movement of the coil member 3 in the aforesaid manner induces electrical current in the coil member 3 that is supplied to the lamp unit 5 via the slide rails 6.

It is apparent to those skilled in the art that the magnet unit can include only one permanent magnet 4, or four permanent magnets 4 embedded in a manner similar to the coil members 3 in the second preferred embodiment so as to achieve substantially the same effect.

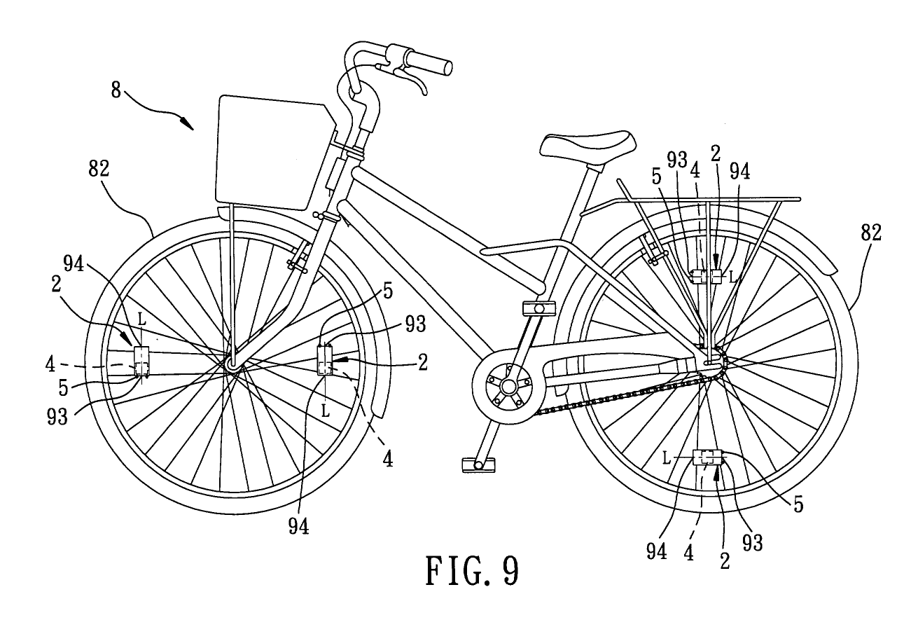

Referring to FIG. 9, the fourth preferred embodiment of an article according to the present invention is shown to include a main body in the form of a wheel 82 of a bicycle 8. The bicycle wheel 82 includes a hub, a wheel rim, and a set of spokes that interconnect the hub and the wheel rim. Casings 2 that incorporate any of the induction generators of the preceding embodiments are mounted on diametrically opposite locations of the bicycle wheel 82, such as on the spokes, with respect to the hub such that the longitudinal axis (L) of the compartment in each casing 2 is disposed transverse to an axis of the hub.

When the induction generator of the first or second embodiment is in use, the coil members 3 maybe connected in series to result in a larger electrical current output. Moreover, each casing 2 may have one lamp unit 5 mounted thereon and connected to the sensing coil unit of the corresponding induction generator.

As the bicycle wheel 82 rotates, the first and second ends 93, 94 of the compartment of each casing 2 alternate between upper and lower positions. Hence, by virtue of gravity, relative movement between the magnet unit and the sensing coil unit occurs in the same manner as described previously in connection with the foregoing embodiments, and induced electrical currents are accordingly generated and are supplied to the lamp units 5 on the casings 2. The light-generating warning effect thus achieved apparently overwhelms the light-reflecting warning effect rendered by conventional reflective stickers in two aspects: First, bright warning light can be generated regardless of ambient light conditions; and second, light can be radiated innumerous directions, which is an improvement as compared to conventional reflective stickers that reflect light only from the lateral sides of the bicycle wheel.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An article comprising:
a main body provided with an elongated compartment that extends along a longitudinal axis, the compartment having opposite first and second ends along the longitudinal axis, the compartment further having a first region adjacent to the first end, and a second region adjacent to the second end, the main body being movable so as to alternate between a first state, where the first end is disposed higher than the second end relative to a horizontal plane, and a second state, where the second end is disposed higher than the first end relative to the horizontal plane;
an electrical load mounted on said main body; and
an induction generator mounted on said main body and including a magnet unit and a sensing coil unit;
wherein one of the magnet unit and the sensing coil unit is movably disposed in the compartment such that said one of the magnet unit and the sensing coil unit moves into the second region of the compartment by virtue of gravity when the main body is at the first state, and such that said one of the magnet unit and the sensing coil unit moves into the first region of the compartment by virtue of gravity when the main body is at the second state;
wherein the other one of the magnet unit and the sensing coil unit is fixed relative to the compartment and is disposed adjacent to one of the first and second regions of the compartment;
wherein back and forth movement of said one of the magnet unit and the sensing coil unit in the first and second regions of the compartment induces electrical current in the sensing coil unit;
wherein the sensing coil unit is coupled electrically to the electrical load so as to supply electrical power thereto when the main body is moved so as to alternate between the first and second states.

2. The article as claimed in claim 1, wherein the sensing coil unit has a coil axis transverse to the longitudinal axis.

3. The article as claimed in claim 2, wherein the main body includes a casing that confines the compartment, the casing having opposite walls that are opposite to each other along the coil axis, the other one of the magnet unit and the sensing coil unit being embedded in at least one of the opposite walls of the casing.

4. The article as claimed in claim 3, wherein the magnet unit includes a permanent magnet movably disposed in the compartment, and the sensing coil unit includes at least one coil member embedded in the opposite walls of the casing.

5. The article as claimed in claim 3, wherein the magnet unit includes at least one permanent magnet embedded in the opposite walls of the casing and the sensing coil unit is movably disposed in the compartment and includes a core and a coil wound on the core.

6. The article as claimed in claim 5, wherein the casing further has a pair of conductive slide rails mounted in the compartment, the slide rails extending parallel to the longitudinal axis and being spaced apart from each other in a direction transverse to the longitudinal and coil axes, the sensing coil unit being in sliding engagement with and establishing electrical connection with the slide rails, the slide rails being coupled electrically to the electrical load.

7. The article as claimed in claim 3, wherein the main body further includes a shoe having a shoe sole, the shoe sole having toe and heel portions opposite to each other along the longitudinal axis, the casing being embedded in the shoe sole between the toe and heel portions.

8. The article as claimed in claim 3, wherein the main body further includes a bicycle wheel having a hub, a wheel rim, and a set of spokes that interconnect the hub and the wheel rim, the casing being mounted on the bicycle wheel such that the longitudinal axis is disposed transverse to an axis of the hub.

9. The article as claimed in claim 8, wherein the casing is mounted on at least one of the spokes.

10. The article as claimed in claim 1, wherein the electrical load is a lamp.
